(19) United States
(12) Patent Application Publication
(10) Pub. No.: US 2011/0033372 A1
(43) Pub. Date: Feb. 10, 2011

(54) Methods for recycling carbonate byproducts in a hydrogen producing reaction

(76) Inventors: William Mays, Commerce, MI (US); Benjamin Reichman, West Bloomfield, MI (US)

Correspondence Address: David W. Schumaker;ENERGY CONVERSION DEVICES, INC., 2956 Waterview Drive, Rochester Hills, MI, 48309, US

(21) Appl. No.: 12/802,069

(22) Filed: May 28, 2010

Related U.S. Application Data
(63) Continuation-in-part of application No. 10/966,001, filed on Oct. 14, 2004, now abandoned.
Application No. 10/966,001 is a continuation-in-part of application No. 10/763,616, filed on Jan. 23, 2004, now Pat. No. 7,481,992.
Application No. 10/763,616 is a continuation-in-part of application No. 10/636,093, filed on Aug. 7, 2003, now Pat. No. 6,994,839.
Application No. 10/636,093 is a continuation-in-part of application No. 12/586,044, filed on Sep. 15, 2009.
Application No. 12/586,044 is a continuation of application No. 10/984,202, filed on Nov. 10, 2004, now Pat. No. 7,588,676.
Application No. 10/984,202 is a continuation-in-part of application No. 10/763,616, filed on Jan. 23, 2004, now Pat. No. 7,481,992.
Application No. 10/763,616 is a continuation-in-part of application No. 10/636,093, filed on Aug. 7, 2003, now Pat. No. 6,994,839.

(51) Int. Cl. C01B 3/02

(52) U.S. Cl. 423/648.1

(57) ABSTRACT

A process for producing hydrogen gas from a reaction of an organic substance and a base with a recycling of a carbonate or bicarbonate by-product and a regeneration of the base. In one embodiment, reaction of an organic substance and a base produces hydrogen gas and a metal carbonate. The instant invention provides recycling of the metal carbonate by-product.

### CROSS-REFERENCE TO RELATED APPLICATIONS

This application is a continuation-in-part of U.S. patent application Ser. No. 10/966,001; which is a continuation-in-part of U.S. patent application Ser. No. 10/763,616 (now U.S. Pat. No. 7,481,992); which in turn is a continuation-in-part of U.S. patent application Ser. No. 10/636,093 (now U.S. Pat. No. 6,994,839), the disclosures of which are all herein incorporated by reference.

This application is also a continuation-in-part of U.S. patent application Ser. No. 12/586,044; which is a continuation of U.S. patent application Ser. No. 10/984,202 (now U.S. Pat. No. 7,588,676); which, in turn, is a continuation-in-part of U.S. patent application Ser. No. 10/763,616 (now U.S. Pat. No. 7,481,992); which is further a continuation-in-part of U.S. patent application Ser. No. 10/636,093 (now U.S. Pat. No. 6,994,839), the disclosures of which are all herein incorporated by reference.

### FIELD OF INVENTION

This invention relates to a process for forming hydrogen gas. More particularly, this invention relates to the production of hydrogen gas from hydrocarbons and oxygenated hydrocarbons through reactions with a base or through electrochemical reaction or electrochemical reaction in the presence of a base. Most particularly, this invention relates to the recovery and reutilization of a by-product formed in the hydrogen producing reactions.

### BACKGROUND OF THE INVENTION

Modern societies are critically dependent on energy to maintain their standards of living and economic viabilities. All aspects of modern life, ranging from the generation of electricity to the powering of automobiles, require the consumption of energy. Conventional fossil fuels are primarily used to meet the energy needs of today's societies. As more societies modernize and existing modern societies expand, the consumption of energy continues to increase at ever growing rates. The increased worldwide use of fossil fuels is creating a number of problems. First, fossil fuels are a finite resource and concern is growing that fossil fuels will become fully depleted in the foreseeable future. Scarcity raises the possibility that escalating costs could destabilize economies as well as the likelihood that nations will go to war over the remaining reserves. Second, fossil fuels are highly polluting. The greater combustion of fossil fuels has prompted recognition of global warming and the dangers it poses to the stability of the earth's ecosystem. In addition to greenhouse gases, the combustion of fossil fuels produces soot and other pollutants that are injurious to humans and animals. In order to prevent the increasingly deleterious effects of fossil fuels, new energy sources are needed.

The desired attributes of a new fuel or energy source include low cost, plentiful supply, renewability, safety, and environmental compatibility. Hydrogen is currently the best prospect for these desired attributes and offers the potential to greatly reduce our dependence on conventional fossil fuels. Hydrogen is the most ubiquitous element in the universe and, if realized, offers an inexhaustible fuel source to meet the increasing energy demands of the world. Hydrogen is available from a variety of sources including coal, natural gas, hydrocarbons in general, organic materials, inorganic hydrides and water. These sources are geographically well distributed around the world and accessible to most of the world's population without the need to import. In addition to being plentiful and widely available, hydrogen is also a clean fuel source. Combustion of hydrogen produces water as a by-product. Utilization of hydrogen as a fuel source thus avoids the unwanted generation of the carbon and nitrogen based greenhouse gases that are responsible for global warming as well as the unwanted production of soot and other carbon based pollutants in industrial manufacturing. Hydrogen truly is a green energy source.

The realization of hydrogen as a ubiquitous source of energy ultimately depends on its economic feasibility. Economically viable methods for producing hydrogen as well as efficient means for storing, transferring, and consuming hydrogen, are needed. Chemical and electrochemical methods have been proposed for the production of hydrogen. The most readily available chemical feedstocks for hydrogen are organic compounds, primarily hydrocarbons and oxygenated hydrocarbons. Common methods for obtaining hydrogen from hydrocarbons and oxygenated hydrocarbons are dehydrogenation reactions and oxidation reactions.

Steam reformation and the electrochemical generation of hydrogen from water through electrolysis are two common strategies currently used for producing hydrogen. Both strategies, however, suffer from drawbacks that limit their practical application and/or cost effectiveness. Steam reformation reactions are thermodynamically unfavorable at room temperature and therefore require temperatures of a few to several hundred degrees to realize acceptable reaction rates. These temperatures are costly to provide, impose special requirements on the materials used to construct the reactors, and limit the range of applications. Steam reformation reactions also occur in the gas phase, which means that hydrogen must be recovered from a mixture of gases through a separation process that adds cost and complexity to the reformation process. Steam reformation also leads to the production of the undesirable greenhouse gases CO₂ and/or CO as by-products. Water electrolysis has not been widely used in practice because high expenditures of electrical energy are required to affect water electrolysis. The water electrolysis reaction requires a high minimum voltage to initiate and an even higher voltage to achieve practical rates of hydrogen production. The high voltage leads to high electrical energy costs for the water electrolysis reaction and has inhibited its widespread use.

In U.S. Pat. Nos. 6,607,707 and 6,890,419 (the disclosures of which are incorporated herein by reference), the instant inventors considered the production of hydrogen from hydrocarbons and oxygenated hydrocarbons. In U.S. Pat. No. 6,607,707, the instant inventors considered the production of hydrogen through reactions of hydrocarbons and oxygenated hydrocarbons with a base. Using a thermodynamic analysis, the instant inventors determined that reactions of many hydrocarbons and oxygenated hydrocarbons react spontaneously with a base or basic aqueous solution to form hydrogen gas at particular reaction conditions, while the same hydrocarbons and oxygenated hydrocarbons react non-spontaneously in conventional steam reformation processes at the same reaction conditions. Inclusion of a base was thus shown to facilitate the formation of hydrogen from many hydrocarbons and oxygenated hydrocarbons and enabled the production of hydrogen at less extreme conditions than those normally encountered in steam reformation reactions.

Representative hydrogen producing reactions disclosed in U.S. Pat. No. 6,607,707 include the reactions of methanol in the presence of a base shown below:

CH₃OH+OH⁻+H₂O⇄3H₂+HCO₃⁻

CH₃OH+2OH+2OH⁻⇄3H₂+CO₃²⁻

As discussed in U.S. Pat. No. 6,607,707, both reactions may occur separately or simultaneously depending on the reaction conditions. The inventors showed that hydrogen was produced from a liquid phase mixture of methanol and a base and that hydrogen was the only gaseous product formed, thereby obviating the need for the gas phase separation required for conventional steam reformation processes. The required reaction temperature was less than the boiling point of the mixture and required only a modest input of energy to effect. Analogous reactions with other hydrocarbons and oxygenated hydrocarbons were also disclosed.

In U.S. Pat. No. 6,890,419, the instant inventors considered electrochemical methods to promote the production of hydrogen from organic substances in the presence of water (e.g. acidic solution) and/or a base. They showed that electrochemical reactions of organic substances with water to produce hydrogen require lower electrochemical cell voltages than water electrolysis. They also showed that electrochemical reactions of organic substances in the presence of an acid or base require low electrochemical cell voltages at room temperature. In some embodiments, hydrogen production reactions of organic substances were shown to occur spontaneously at room temperature in an electrochemical reaction and were accelerated by heating. In other embodiments, hydrogen production reactions of organic substances were shown to occur spontaneously at room temperature without applying a voltage and were accelerated by providing a voltage.

A representative example of a hydrogen-producing electrochemical reaction disclosed in U.S. Pat. No. 6,890,419 is a reaction of methanol with a base in the presence of an electrochemical potential. The corresponding electrochemical reactions are shown below:

$$\frac{\begin{matrix}{CH}_{3} {OH}_{( 1 )} + 7 {OH}_{( aq )}^{-} ⇆ {HCO}_{3 ( aq )}^{-} + 5 {H}_{2} {O}_{( 1 )} + \\ 6 {e}^{-} 6 {H}_{2} {O}_{( 1 )} + 6 {e}^{-} ⇆ 3 {H}_{2 ( g )} + 6 {OH}_{( aq )}^{-}\end{matrix}}{{CH}_{3} {OH}_{( 1 )} + {OH}_{( aq )}^{-} + {H}_{2} {O}_{( 1 )} ⇆ {HCO}_{3 ( aq )}^{-} + 3 {H}_{2 ( g )}}$$

$$\frac{\begin{matrix}( anode , oxidation ) \\ ( cathode , reduction )\end{matrix}}{( overall )}$$

Methanol may also react with two equivalents of hydroxide ion to produce hydrogen gas according to the following electrochemical reactions:

$$\frac{\begin{matrix}{CH}_{3} {OH}_{( 1 )} + 8 {OH}_{( aq )}^{-} ⇆ {CO}_{3 ( aq )}^{2 -} + 6 {H}_{2} {O}_{( 1 )} + \\ 6 {e}^{-} 6 {H}_{2} {O}_{( 1 )} + 6 {e}^{-} ⇆ 3 {H}_{2 ( g )} + 6 {OH}_{( aq )}^{-}\end{matrix}}{{CH}_{3} {OH}_{( 1 )} + 2 {OH}_{( aq )}^{-} ⇆ {CO}_{3 ( aq )}^{2 -} + 3 {H}_{2 ( g )}}$$

$$\frac{\begin{matrix}( anode , oxidation ) \\ ( cathode , reduction )\end{matrix}}{( overall )}$$

The amount of base present in the reaction mixture influences whether methanol reacts primarily with one or two equivalents of hydroxide ion in the overall reaction. In principle, both reactions can occur simultaneously and in practice, the specific reaction conditions determine whether one overall reaction is more important than the other overall reaction. The instant inventors also showed that the electrochemical reactions of methanol with one or two equivalents of hydroxide ion occur spontaneously at room temperature and that application of an electrochemical potential increased the rate of hydrogen production from each reaction. Similarly beneficial effects were disclosed for electrochemical reactions of other organic substances.

Bases which are suitable for the reactions disclosed in U.S. Pat. Nos. 6,607,707 and 6,890,419 are compounds that provide hydroxide ions. Metal hydroxides are the preferred bases. Representative metal hydroxides include alkali metal hydroxides (e.g. NaOH, KOH etc.) alkaline earth metal hydroxides (e.g. Ca(OH)₂, Mg(OH)₂, etc.), transition metal hydroxides, post-transition metal hydroxides and rare earth hydroxides. Non-metal hydroxides such as ammonium hydroxide may also be used.

Realization of the beneficial properties of reactions that produce hydrogen from organic substances and bases requires a system level consideration of the costs and overall efficiency of the reactions. In addition to energy inputs and raw materials, consideration of the disposal or utilization of by-products must be made. Many of the reactions of a base with hydrocarbons, oxygenated hydrocarbons and other organic substances discussed in the co-pending parent applications involve the formation of the carbonate ion (CO₃²⁻) or bicarbonate ion (HCO₃⁻) as a by-product. In order to enhance the efficiency and economic viability of these reactions, it is necessary to devise ways to effectively dispense with the carbonate ion and/or bicarbonate ion by-products. It is particularly desirable to dispense with by-products in such a way as to avoid the production of environmentally harmful gases and/or in such a way as to regenerate the base reactant.

### SUMMARY OF THE INVENTION

The instant invention provides a process for producing hydrogen gas from reactions of organic substances with bases in which carbonate and/or bicarbonate ion is produced as a by-product. The instant process includes a carbonate ion recycle process by recovering the metal hydroxide base from the metal carbonate and recycling the metal hydroxide base to be reacted again with more organic substance. The metal of the metal hydroxide may be one or more metals from the group consisting of Na, K and Li.

The step of recovering said metal hydroxide may be recausticization. Recausticization may include the steps of: a) decarbonization of said carbonate to form an intermediary product and CO₂ gas; and b) hydrolysis of said intermediary product to form said metal hydroxide. The step of decarbonization of the carbonate may include reacting the carbonate with a decarbonization agent. The step of hydrolysis of the intermediary product may form the metal hydroxide and reform the decarbonization agent.

The recausticization may be direct causticization and the decarbonization agent may be insoluble in alkaline solution. The decarbonization agent for direct causticization may be a titanium oxide, a manganese oxide, or an iron oxide. The recausticization may be autocausticization and the decarbonization agent may be soluble in alkaline solution. The decarbonization agent for autocausticization may be a borate salt, a phosphate salt, a silicate salt, or an aluminate. The recausticization may be thermal decomposition causticization and the decarbonization agent may be heat.

### DETAILED DESCRIPTION OF THE INVENTION

The instant invention is concerned with the recovery and recycling of caustic from carbonate and bicarbonate ion by-products formed in reactions of organic substances with bases to produce hydrogen gas. The hydrogen producing reactions have been previously described in U.S. Pat. Nos. 6,607,707 and 6,890,419. The hydrogen producing reactions generally involve the reaction of an organic substance with a base to produce hydrogen gas along with bicarbonate and/or carbonate ion as a by-product. Representative reactions are described in the Background section hereinabove. The reactions may occur in a liquid phase in which the base is at least partially soluble. Hydrogen gas is the only gas formed in the reaction and is recovered as it evolves from the liquid. The liquid phase may also include water and the base may be added in the form of an aqueous solution. The hydrogen producing reaction may be chemical or electrochemical in nature.

The instant invention provides processes for recycling carbonate and bicarbonate ion by-products and recovery of the caustic. The invention is initially illustrated in the context of carbonate ion by-products. Similar considerations apply to bicarbonate ion by-products and will be described later herein.

One embodiment of the instant invention focuses on the carbonate ion by-product that forms in many of the hydrogen producing reactions. Hydrogen producing reactions that form a carbonate ion by-product may generally be written:

organic substance+metal hydroxide→hydrogen gas+metal carbonate (I)

where water may also be present as a reactant. Organic substances that react according to the hydrogen producing reaction (I) may include hydrocarbons (purely as non-limiting examples, alkanes, alkenes, alkynes and substituted forms thereof) and oxygenated hydrocarbons (purely as non-limiting examples, alcohols, aldehydes, ketones, ethers, carboxylic acids and substituted forms thereof).

The instant invention provides a recycle process for the carbonate by-product formed in the hydrogen producing reaction (I). In one embodiment, the metal carbonate product is a soluble metal carbonate and a three-step recycle process as shown below is provided:

metal carbonate+metal* hydroxide→metal hydroxide+metal* carbonate (A)

metal* carbonate+heat→metal* oxide+carbon dioxide (B)

metal* oxide+water→metal* hydroxide (C)

where metal and metal* refer to different metals and metal* carbonate is a solid. In another embodiment, the metal carbonate product of the hydrogen producing reaction (I) is a solid and a two-step recycle process according to reactions (B) and (C) above is provided. Further description and examples of specific embodiments of the instant recycle process are provided hereinbelow.

The recycle process of the instant is conveniently discussed in the context of a representative hydrogen producing reaction (I) as shown above. As an example, the reaction of methanol (CH₃OH) with sodium hydroxide (NaOH) in an aqueous medium may be considered. Methanol and sodium hydroxide react to produce hydrogen gas according to the following reaction labeled (II):

CH₃OH₍ₗ₎+2NaOH_{(aq)}→3H_{2(g)}+Na₂CO_{3(aq)} (II)

The by-product in this reaction, sodium carbonate (Na₂CO₃), is a soluble carbonate salt that remains in solution upon liberation of hydrogen gas. In solution, sodium carbonate dissociates into sodium ions (Na⁺) and carbonate ions (CO₃⁻). Instead of discarding the sodium carbonate by-product solution as a waste product of the reaction, the instant invention seeks to reutilize the carbonate ion in a recycle process.

One embodiment of the instant carbonate recycling process is now described. In this embodiment, the sodium carbonate by-product solution is reacted in a three step recycle process summarized by the following reactions:

Na₂CO_{3(aq)}+Ca(OH)_{2(aq)} [symbol] 2NaOH_{(aq)}+CaCO₃₍ₛ₎ (1)

CaCO₃₍ₛ₎+heat→CaO₍ₛ₎+CO_{2(g)} (2)

CaO₍ₛ₎+H₂O₍ₗ₎→Ca(OH)_{2(aq)} (3)

In the first step, a carbonate metathesis reaction step, sodium carbonate reacts with calcium hydroxide to form sodium hydroxide and calcium carbonate. The sodium hydroxide produced is soluble and remains in solution. The calcium carbonate is nearly insoluble in solution and consequently precipitates upon its formation in the reaction. The solution phase of the product of the first reaction substantially comprises aqueous sodium hydroxide. The calcium carbonate solid can be separated from the solution phase and the solution phase can subsequently be used as the base reactant in the hydrogen producing reaction (II) described hereinabove. In the second step, a metal carbonate thermal decomposition step, the solid calcium carbonate is thermally decomposed to form calcium oxide and carbon dioxide and in the third step, the calcium oxide is reacted with water to form calcium hydroxide. The calcium hydroxide formed in the third step can be subsequently utilized in further implementations of the recycle process.

The instant recycle process beneficially dispenses with the carbonate ion formed in the hydrogen producing reaction. The recycle process is sustainable in the sense that the calcium hydroxide reactant required in the first step is regenerated in the third step. Thus, the need for fresh calcium hydroxide is limited only to amounts needed to compensate for any side reactions or other inefficiencies in the recycle process. The combination of the hydrogen producing reaction and recycle process is also sustainable in the sense that the sodium hydroxide reactant required for the hydrogen producing reaction is generated in the first step of the recycle process. This can be seen by combining the hydrogen producing reaction (II) and the recycle reaction (1), (2), and (3) to obtain the following overall net reaction:

CH₃OH₍ₗ₎+H₂O₍ₗ₎→3H_{2(g)}+CO_{2(g)}

The net reaction is simply a reaction of methanol with water to form hydrogen gas and carbon dioxide. The net reaction corresponds closely to the reaction utilized in conventional steam reformation, but differs in that high temperatures and thus gaseous methanol and water (steam) reactants are not necessary in the instant process. Instead, through chemical or electrochemical reaction with a base and recycling of carbonate by-product it becomes possible with the instant invention to achieve the production of hydrogen from organic substances at milder conditions without the co-generation of carbon monoxide.

The foregoing example is representative of carbonate recycling according to the instant invention. Specific considerations pertinent to different embodiments are governed by the solubilities of some of the compounds participating in the reactions. Of greatest concern are the solubility of the metal hydroxide base reactant used in the hydrogen producing reaction (I), the solubility of the metal carbonate product formed in the hydrogen producing reaction (I), and the solubility of the metal carbonate product formed in the metathesis step of the recycle process. In a preferred embodiment, the hydrogen producing reaction (I) employs a soluble metal hydroxide. This embodiment is preferred because a soluble metal hydroxide base in the hydrogen producing reaction (I) facilitates hydrogen reaction and provides faster rates of hydrogen production. The solubility of a metal hydroxide compound can be determined by considering the solubility product constant (Kₛₚ) of the compound. Metal hydroxides with high solubility product constants are more soluble than metal hydroxides with low solubility product constants. The more soluble metal hydroxides include hydroxides of the alkali metals, Ca²⁺, Sr²⁺, Ba²⁺ and NH₄⁺. The foregoing example employs sodium hydroxide as the base reactant in the hydrogen producing reaction (II).

The metal carbonate formed in the hydrogen producing reaction (I) is the carbonate of the metal cation present in the metal hydroxide base of the hydrogen producing reaction. The solubility of the metal carbonate product is thus dictated by the metal hydroxide base selected for the hydrogen producing reaction. The solubility of the carbonate of a metal frequently, but not always, mirrors the solubility of the hydroxide of the metal. Typically, carbonates of metals whose hydroxides are soluble are also soluble. Exceptions, however, do exist. The solubility of particular metal carbonate can be determined by considering its solubility product constant (Kₛₚ). The more soluble metal carbonates include carbonates of the alkali metals and NH₄⁺. In the foregoing example, sodium hydroxide was employed as the base reactant in the hydrogen producing reaction (II) and led to the formation of sodium carbonate where both sodium hydroxide and sodium carbonate are soluble. Use of, for example, calcium hydroxide as the base reactant in the hydrogen producing reaction leads to the formation of calcium carbonate, a relatively insoluble compound, and is considered in an alternative embodiment hereinbelow.

In the instant recycle process, it is preferable for the metal carbonate formed in the hydrogen producing reaction (I) to be soluble. This preference arises because the metal carbonate formed in the hydrogen producing reaction (I) becomes a reactant in the metathesis step of the recycle process and follows from the fact that the metathesis reaction occurs more efficiently with a soluble metal carbonate reactant. A related rationale for the preference follows from the desire to achieve sustainability with respect to the metal hydroxide in the hydrogen producing reaction. As indicated above, it is preferable for the metal hydroxide reactant in the hydrogen producing reaction to be soluble. This implies a preference that the metal hydroxide product of the carbonate metathesis reaction of the recycle process be soluble, since this metal hydroxide is ultimately reutilized in the hydrogen producing reaction. A soluble metal carbonate reactant in the metathesis reaction facilitates the objective of obtaining a soluble metal hydroxide product since, in virtually all cases, metal ions having soluble carbonates also have soluble hydroxides.

The solubility of the metal hydroxide product of the metathesis reaction of the recycle process influences the preferred degree of solubility of the metal carbonate formed in the metathesis reaction and accordingly, influences the selection of metal hydroxide reactant employed in the metathesis reaction. In order to expedite separation of the products of the metathesis step, it is preferable that the metal carbonate product and the metal hydroxide product have contrasting solubilities so that one of the products is substantially in one phase (e.g. a liquid phase) and the other of the products is in a second phase (e.g. solid or precipitate phase). A solubility contrast simplifies separation of one product from the other. In light of the preference discussed hereinabove that the metal hydroxide product of the metathesis reaction be soluble, this consideration leads to a preference that the metal carbonate product of the metathesis reaction be insoluble or only weakly soluble. The solubility contrast (soluble vs. insoluble or weakly soluble) facilitates separation of the metal hydroxide product (which may be returned to the hydrogen producing reaction for further reaction) and the metal carbonate product (which contains the carbonate ion by-product of the hydrogen producing reaction and which is subsequently reacted in decomposition and hydrolysis reactions of the recycle process).

The solubility of the metal carbonate product formed in the metathesis reaction can be influenced by the selection of metal hydroxide reactant employed in the metathesis reaction. More specifically, the metal cation of the metal hydroxide reactant combines with the carbonate ion of the metal carbonate reactant (which is the metal carbonate product of the hydrogen producing reaction) to form the metal carbonate product of the metathesis reaction. Choice of the metal cation of the metal hydroxide reactant thus becomes a degree of freedom in controlling whether the metal carbonate product of the metathesis reaction precipitates. Precipitation is promoted through the use of a metal hydroxide reactant whose metal cation has a low carbonate Kₛₚ value. The Kₛₚ values of several weakly soluble or insoluble metal carbonates are included in Table 1 below:

TABLE 1
Solubility Product Constant (Kₛₚ) Values of
Representative Metal Carbonates at 25° C.

| Compound | Kₛₚ |
|---|---|
| CaCO₃ | 3.3 × 10⁻⁹ |
| BaCO₃ | 2.0 × 10⁻⁹ |
| CdCO₃ | 1.8 × 10⁻¹⁴ |
| CoCO₃ | 1.0 × 10⁻¹⁰ |
| CuCO₃ | 3 × 10⁻¹² |
| PbCO₃ | 7.4 × 10⁻¹⁴ |
| MgCO₃ | 3.5 × 10⁻⁸ |
| NiCO₃ | 1.3 × 10⁻⁷ |
| SrCO₃ | 5.4 × 10⁻¹⁰ |
| ZnCO₃ | 1.0 × 10⁻¹⁰ |
| FeCO₃ | 3.5 × 10⁻¹¹ |

Use of a metal hydroxide reactant that includes a cation from represented in the carbonates of Table 1, promotes the formation of a carbonate precipitate in the metathesis reaction. In the foregoing example, calcium hydroxide was used as the metal hydroxide reactant in the metathesis reaction. The cation of calcium hydroxide combined with the carbonate ion of the (soluble) sodium hydroxide to form weakly soluble calcium carbonate (Kₛₚ=3.3×10⁻⁹) in the metathesis reaction. The selection of calcium hydroxide as a reactant thus permitted the formation of a weakly soluble metal carbonate in the metathesis reaction. Through consideration of Kₛₚ, other suitable metal hydroxide reactants may be similarly identified to promote the formation of weakly soluble or insoluble metal carbonate products. Use of barium hydroxide (Ba(OH)₂), for example, as the metal hydroxide reactant in the metathesis reaction leads to formation of weakly soluble and hence readily precipitatable BaCO₃. Preferably, the Kₛₚ value of the metal carbonate product is less than 10⁻⁶.

A secondary consideration in the selection of the metal hydroxide reactant of the metathesis reaction is its solubility. As indicated hereinabove, the metal hydroxide reactant of the metathesis reaction reacts with the metal carbonate product of the hydrogen producing reaction where the metal carbonate product is preferably soluble and provided in the form of an aqueous solution as a reactant for the metathesis reaction. In this preferred embodiment, it is preferable for the metal hydroxide reactant of the metathesis reaction to be at least partially soluble in the metal carbonate reactant solution so that the reaction proceeds at a reasonable rate. High solubility of the metal hydroxide reactant is not needed, however, because precipitation of the carbonate product shifts the metathesis reaction equilibrium toward the product side and helps to drive the reaction even if the metal hydroxide reactant is only weakly soluble. Consequently, subject to the preference described hereinabove of obtaining a weakly soluble or insoluble carbonate product in the metathesis reaction, selection of the metal hydroxide reactant in the metathesis reaction should include consideration of its solubility. As indicated hereinabove, hydroxides of the alkali metals, Ca²⁺, Sr²⁺, and Ba²⁺ are among the most soluble. Hydroxides of the alkali metals, while preferred as reactants in the hydrogen producing reaction, are less preferred as reactants in the metathesis reaction since they produce carbonates that are soluble. Ca²⁺, Sr²⁺, and Ba²⁺, in contrast, provide weakly soluble carbonates and have hydroxides that are sufficiently soluble to promote the metathesis reaction. Consequently, hydroxides of Ca²⁺, Sr²⁺, and Ba²⁺ are the preferred metal hydroxide reactants in the metathesis reaction.

A preferred embodiment of the instant invention thus includes a soluble metal hydroxide reactant that leads to the formation of a soluble metal carbonate in the hydrogen producing reaction and a metal hydroxide reactant in the metathesis reaction whose carbonate compound is weakly soluble or insoluble. Alkali metal hydroxides are the preferred reactants in the hydrogen producing reaction since they form highly soluble carbonates, while the hydroxides of Ca²⁺, Sr²⁺, and Ba²⁺ are the preferred metal hydroxide reactants in the metathesis reaction. In an example of a preferred embodiment, the following general metathesis reaction may be written:

M₂CO_{3(aq)}+M′(OH)_{2(aq)}→2MOH_{(aq)}+M′CO₃₍ₛ₎

where M is an alkali metal and M′ is Ca²⁺, Sr²⁺, or Ba²⁺. The metal hydroxide product MOH is soluble and is produced in the form of an aqueous MOH solution and the metal carbonate product M′CO₃ is formed as a precipitate.

The precipitated metal carbonate product of the metathesis reaction is decomposed in a thermal decomposition step (e.g. step 2 in the foregoing example) to form a metal oxide and carbon dioxide gas. Carbonate thermal decomposition is a well-known reaction and essentially all metal carbonates undergo decomposition. Thermal decomposition of metal carbonates can be depicted generally by the following reaction:

MCO₃₍ₛ₎+heat→MO₍ₛ₎+CO_{2(g)}

The above reaction is written for a divalent metal (M²⁺). Analogous reactions can be written for carbonates of metals that are monovalent, trivalent etc.

The metal oxide formed in the decomposition step is subsequently reacted with water to form a hydroxide (e.g. step 3 in the foregoing example). The general reaction for this step can be written:

MO₍ₛ₎+H₂O₍ₗ₎→M(OH)_{2(aq)}

The above reaction is written for a divalent metal (M²⁺). Analogous reactions can be written for carbonates of metals that are monovalent, trivalent etc.

In an alternative embodiment of the instant invention, the hydrogen producing reaction (I) provides a solid metal carbonate as a product. This situation occurs when the metal carbonate product of the hydrogen producing reaction (I) is insoluble or weakly soluble and is present when the carbonate of the metal cation employed in the metal hydroxide base reactant of the hydrogen producing reaction (I) is weakly soluble or insoluble. When a solid carbonate is formed in the hydrogen producing reaction (I), it may be recycled by thermal decomposition to form a metal oxide and carbon dioxide followed by reaction of the metal oxide with water to reform the metal hydroxide initially employed in the hydrogen producing reaction.

Representative hydrogen producing reactions in accordance with this embodiment are those that include metal hydroxide reactants other than the hydroxides of the alkali metals or NH₄⁺, since the alkali metals and NH₄⁺ form soluble carbonates and are recycled according to the method described hereinabove. Of the remaining potential metal hydroxide reactants in the hydrogen producing reaction (I), those that are at least partially soluble are preferred in this embodiment. Representative metal hydroxide reactants that are sufficiently soluble to be effective for the hydrogen producing reaction (I) and that provide weakly soluble or insoluble metal carbonate products include the hydroxides of Ca²⁺, Sr²⁺, and Ba²⁺.

An example according to this embodiment is a reaction of ethanol (C₂H₅OH) with Sr(OH)₂. The hydrogen producing reaction of this example is:

C₂H₅OH₍ₗ₎+2Sr(OH)_{2(aq)}+H₂O₍ₗ₎→6H_{2(g)}+2SrCO₃₍ₛ₎

where the strontium carbonate product precipitates due to its low solubility product constant. The carbonate product may be recycled through thermal decomposition followed by reaction with water according to the following reactions:

SrCO₃₍ₛ₎+heat→SrO₍ₛ₎+CO_{2(g)}

SrO₍ₛ₎+H₂O₍ₗ₎→Sr(OH)_{2(aq)}

In this recycle process, the strontium hydroxide reactant originally employed in the hydrogen producing reaction is regenerated. Analogous reactions can be written for other organic substances and other metal hydroxides that react in a hydrogen producing reaction according to the instant invention to produce an insoluble or weakly soluble metal carbonate.

Related variations of the foregoing embodiment include embodiments in which carbonate recovery or partial carbonate recycling occur. In these embodiments, less than all of the three steps of the recycling process described hereinabove are employed. The metal carbonate formed in the hydrogen producing reaction, for example, may be directly recovered and discarded or utilized for other purposes. The metal carbonate formed in the hydrogen producing reaction may also be reacted in the metathesis reaction described hereinabove to form a different metal carbonate that is subsequently discarded or utilized for other purposes. The metal carbonate formed in the metathesis reaction may be thermally decomposed to form an oxide without further reaction of the oxide with water. Similarly, a solid metal carbonate formed in the hydrogen producing reaction may be thermally decomposed to form an oxide without further reaction with water.

As indicated hereinabove, the hydrogen producing reactions described in the co-pending parent applications may also produce a bicarbonate ion by-product. The formation of bicarbonate ion becomes favorable under conditions of lower metal hydroxide base concentration and lower pH relative to implementations of the instant hydrogen producing reactions that lead to the formation of carbonate ion as a by-product. Representative pH ranges that tend to favor the formation of carbonate vs. bicarbonate by-products have been discussed in the co-pending parent applications.

Hydrogen producing reactions that form a bicarbonate by-product may generally be written:

organic substance+metal hydroxide+water→hydrogen gas+metal bicarbonate (III)

Organic substances that react according to the hydrogen producing reaction (I) include hydrocarbons (e.g. alkanes, alkenes, alkynes and substituted forms thereof) and oxygenated hydrocarbons (e.g. alcohols, aldehydes, ketones, ethers, carboxylic acids and substituted forms thereof).

Embodiments of the instant invention provide a recycle process for the bicarbonate by-product formed in the hydrogen producing reaction (III). In one embodiment, the metal bicarbonate product of the hydrogen producing reaction (III) is converted to a metal carbonate and the metal carbonate is recycled as described in reactions (A), (B), and (C) described hereinabove. Conversion of a metal bicarbonate to a metal carbonate can be effected through heating, as indicated in the following reaction:

metal bicarbonate+heat→metal carbonate+water+carbon dioxide

The foregoing reaction occurs for aqueous solutions of metal bicarbonates or precipitated metal bicarbonates.

As an example of bicarbonate recycling according to the instant invention, the following hydrogen producing reaction may be considered:

CH₃OH₍ₗ₎+KOH_{(aq)}+H₂O₍ₗ₎→3H_{2(g)}+KHCO_{3(aq)}

The bicarbonate by-product, in the form of an aqueous solution of KHCO₃, may be recycled by first converting it to a carbonate through the reaction:

2KHCO_{3(aq)}+heat→K₂CO_{3(aq)}+H₂O₍ₗ₎+CO_{2(g)}

and then reacting the carbonate as described hereinabove through a series of reactions such as:

K₂CO_{3(aq)}+Ba(OH)_{2(aq)} [symbol] 2KOH_{(aq)}+BaCO₃₍ₛ₎ (4)

BaCO₃₍ₛ₎+heat→BaO₍ₛ₎+CO_{2(g)} (5)

BaO₍ₛ₎+H₂O₍ₗ₎→Ba(OH)_{2(aq)} (6)

As another example of bicarbonate recycling according to the instant invention, the following reaction can be considered:

CH₃OH₍ₗ₎+Sr(OH)_{2(aq)}+2H₂O₍ₗ₎→5H_{2(g)}+Sr(HCO₃)₂₍ₛ₎

where the bicarbonate product is provided in the form of a precipitate. The bicarbonate precipitate may be dispensed with through conversion to a carbonate and recycling of the carbonate as described hereinabove according to the reactions:

Sr(HCO₃)₂₍ₛ₎+heat→SrCO₃₍ₛ₎+H₂O₍ₗ₎+CO_{2(g)}

SrCO₃₍ₛ₎+heat→SrO₍ₛ₎+CO_{2(g)}

SrO₍ₛ₎+H₂O₍ₗ₎→Sr(OH)_{2(aq)}

### Recovery of NaOH from Na₂CO₃ at High OH Concentration

A potential problem with recycling/recausticizing of Na₂CO₃ to NaOH using CaO/Ca(OH)₂ is the amount of NaOH recovered from the reaction is reduced at high NaOH concentration due to the thermodynamic equilibrium of the reaction. At NaOH concentrations over 10% by weight, the amount of NaOH that can be recovered from the Na₂CO₃ falls off dramatically. In some industries, such as the paper industry, this may not be an issue because they use a lower NaOH concentration (˜10%). However, in the present hydrogen formation processes it may be beneficial or even essential to use high NaOH concentrations. Thus, other processes for recycling/recovering the carbonate are necessary. Further, such other processes may be more cost effective and/or simpler to implement with respect to the present hydrogen production reactions.

### Alternative Causticization Processes

The current drawbacks of the conventional lime causticization recovery process highlighted above are the rationale for research on possible alternative recovery processes. There are three basic types of alternative causticization processes that are considered herein: 1) direct causticization; 2) autocausticization; and 3) thermal decomposition causticization. In the first two cases an oxide is used as the causticizing agent. If the oxide is soluble in water it is called autocausticization and if insoluble it is known as direct causticization. In the third case the carbonate is directly decomposed to an oxide and then hydrolyzed to reform the hydroxide. In each case a decarbonization agent removes the CO₂ from the carbonate forming an intermediary product. This intermediary product is then reacted with water to form the hydroxide and reform the decarbonization agent.

### Direct Causticization

In direct causticization the oxide is insoluble in alkaline solutions and precipitates during the dissolution/hydrolysis phase. The causticizing agent is a metal oxide agent, such as titanium oxide, manganese oxide, and iron oxide. Because it is precipitated, the hydrated metal oxide complex can easily be recovered from the recausticized solution and be recycled. Overall advantages to direct causticization include the elimination of the lime cycle, reduction in dead-load of sodium carbonate, and the high concentration of sodium hydroxide in the recovery solution.

The recovery/recycle of the base (caustic) from the carbonate byproduct occurs in two steps. The first step is the decarbonization of the carbonate via reaction with a decarbonization agent (DA), and the second step is the hydrolysis of the oxide to recover the base (caustic) and the decarbonization agent (DA). The decarbonization reaction occurs in the solid or molten state and as such, any water or other solvating liquid must first be evaporated from the carbonate byproduct. The decarbonization reaction is essentially:

DA(s)+MCO₃(s) [symbol] MO-DA(s)+CO₂(g)

where DA is the solid decarbonization agent, MCO₃ is the metal carbonate byproduct, and MO-DA is the decarbonization complex material that is further processed in the hydrolysis step. Once the decarbonization reaction is complete, the decarbonization complex material is reacted with excess water in a hydrolysis reaction to reform the DA and the base (caustic) as follows:

2MO-DA(s)+H₂O [symbol] 2DA(s)+2MOH(aq)

where MOH is the caustic base used to react with the organic and produce the hydrogen and carbonate byproduct.

Typical oxides used as the decarbonization agent in direct causticization are titanium oxides, iron oxides, and manganese oxides. Specific examples are TiO₂, Fe₂O₃, and Mn₂O₃. When using TiO₂ to recover/recycle a Na₂CO₃ byproduct, the decarbonization reaction can be generically stated as:

bTiO₂+aNa₂CO₃ [symbol] aNa₂O.bTiO₂+aCO₂(g)

Although quite a few chemical species of the form of aNa₂O.bTiO₂ can be formed during the decarbonization reaction, only a few of them are stable at the reaction temperatures. They are sodium hexatitanate, Na₂O.6TiO₂, sodium tri-titanate, Na₂O.3TiO₂, sodium penta-titanate, 4Na₂O.5TiO₂, and sodium meta-titanate, Na₂O.TiO₂. With this information, the reaction can be simplified into two major reactions and three less important reactions. The two major reactions are:

Na₂CO₃(s)+3TiO₂(s) [symbol] Na₂O.3TiO₂(s)+CO₂(g)

and

5(Na₂O.3TiO₂)(s)+7Na₂CO₃(s) [symbol] 3(4Na₂O.5TiO₂)(s)+7CO₂(g)

The other reactions are:

6TiO₂(s)+Na₂CO₃(s) [symbol] Na₂O.6TiO₂(s)+CO₂(g)

Na₂O.6TiO₂(s)+Na₂CO₃(s) [symbol] 2(Na₂O.3TiO₂)(s)+CO₂(g)

4Na₂O.5TiO₂(s)+Na₂CO₃(s) [symbol] 5(Na₂O.TiO₂)(s)+CO₂(g)

It has been found that these minor reactions do not play a significant role in the decarbonization, and the main reactions are considered to be the decarbonization reactions.

After sodium penta-titanate is formed, the hydrolysis (reaction with water) thereof decomposes the sodium penta-titanate to form sodium hydroxide and sodium tri-titanate via the reaction:

3(4Na₂O.5TiO₂)(s)+7H₂O [symbol] 5(Na₂O.3TiO₂)(s)+14NaOH(aq)

Sodium trititanate is insoluble in the alkali solution. It is filtered off and recycled to the decarbonization reaction. The aqueous solution of sodium hydroxide is recycled to the hydrogen production reaction.

Similar to the titanates, the decarbonization reaction with iron oxide is quite complicated because sodium ferrite and ferric oxide have a number of crystal forms and the actual reaction mechanism depends on temperature and the crystal forms involved. For temperatures above 850° C. when carbon dioxide pressure has a minor influence on the decarbonization reaction rate, the main decarbonization reaction is:

Fe₂O₃(s)+Na₂CO₃(s) [symbol] 2NaFeO₂(s)+CO₂(g)

and the hydrolysis reaction is:

2NaFeO₂(s)+H₂O(l) [symbol] 2NaOH(aq)+Fe₂O₃(s)

As with the titanates, the Fe₂O₃ is insoluble in the alkali solution. It is filtered off and recycled to the decarbonization reaction and the aqueous solution of sodium hydroxide is recycled to the hydrogen production reaction.

During direct causticization using manganese oxides, MnO₂ is first reduced to Mn₂O₃ at temperatures between 500° C. and 700° C. It further forms Mn₃O₄ at temperatures between 900° C. and 950° C. Therefore the decarbonization agent in the direct causticizing reaction based on manganese should be Mn₃O₄. The reactions of decarbonization and hydrolysis can be written as:

Mn₃O₄(s)+Na₂CO₃(s) [symbol] 2NaMnO₂(s)+MnO(s)+CO₂

and

2NaMnO₂(s)+MnO(s)+H₂O(l) [symbol] 2NaOH(aq)+Mn₃O₄(s)

Once again, the Mn₃O₄ is insoluble in the alkali solution and is recycled to the decarbonization reaction, while the aqueous solution of sodium hydroxide is recycled to the hydrogen production reaction.

### Autocausticization

Autocausticization processes are similar to the Direct Cauticization process but use amphoteric salts that release carbon dioxide (CO₂) from sodium carbonate (Na₂CO₃) in the decarbonization process. These salts are soluable in the alkaline solution. The caustic (hydroxide, e.g. NaOH) is recovered by hydrolysis of the reaction product.

As with the Direct Causticization, the recovery/recycle of the base (caustic) from the carbonate byproduct occurs in two steps. The first step is the decarbonization of the carbonate via reaction with the amphoteric salt decarbonization agent (DA), and the second step is the hydrolysis of the oxide to recover the base (caustic) and the decarbonization agent (DA). The decarbonization reaction occurs in the solid or molten state and as such, any water or other solvating liquid must first be evaporated from the carbonate byproduct. The decarbonization reaction is essentially:

DA(s)+MCO₃(s) [symbol] MO-DA(s)+CO₂(g)

where DA is the solid (or molten) decarbonization agent, MCO₃ is the solid (or molten) metal carbonate byproduct, and MO-DA is the decarbonization complex material that is further processed in the hydrolysis step. Once the decarbonization reaction is complete, the decarbonization complex material is reacted with excess water in a hydrolysis reaction to reform the DA and the base (caustic) as follows:

2MO-DA(s)+H₂O [symbol] 2DA(aq)+2MOH(aq)

where MOH is the caustic base used to react with the organic and produce the hydrogen and carbonate byproduct. As can be seen, the decarbonization agent is soluble in the alkaline solution formed upon hydrolysis and as such the decarbonization agent is recycled to the primary hydrogen production reactor along with the caustic.

The most promising of the autocausticizing processes is borate (boron oxide)-based autocausticizing. Other materials used in autocauticization include phosphate (phosphorus oxide)-based, silicate-based and aluminate-based salts.

In borate autocausticization, a borate salt such as NaBO₂ is reacted with the carbonate byproduct (e.g. Na₂CO₃) to release carbon dioxide (CO₂) and form a more complex boron oxide. Examples of the borate decarbonization reaction are:

2NaBO₂(s)+Na₂CO₃(s) [symbol] Na₄B₂O₅(s)+CO₂(g)

and

NaBO₂(s)+Na₂CO₃(s) [symbol] Na₃BO₃(s)+CO₂(g)

The corresponding hydrolysis reactions for these borate decarbonization reactions are:

Na₄B₂O₅(s)+H₂O(l) [symbol] 2NaBO₂(aq)+2NaOH(aq)

and

Na₃BO₃(s)+H₂O(l) [symbol] NaBO₂(aq)+2NaOH(aq).

Since the NaBO₂ is soluble in the alkaline solution, it is recycled to the primary hydrogen production reactor along with the caustic (NaOH). This poses no problem in that the NaBO₂ does not react with the carbonate formed in the reactor at the reaction temperatures of the hydrogen production reactor.

Phosphate autocausticization reactions are similar to the borate ones. The specific reactions are:

Na₄P₂O₇(s)+Na₂CO₃(s) [symbol] 2Na₃PO₄(s)+CO₂(g)

and

2Na₃PO₄(s)+H₂O(l) [symbol] Na₄P₂O₇(aq)+2NaOH(aq).

Silicate autocausticization reactions are similar to the borate ones. The specific reactions are:

Na₂Si₂O₅(s)+Na₂CO₃(s) [symbol] 2Na₂SiO₃(s)+CO₂(g)

and

2Na₂SiO₃(s)+H₂O(l) [symbol] Na₂Si₂O₅(aq)+2NaOH(aq).

Aluminate autocausticization reactions are similar to the borate ones. The specific reactions are:

Al₂O₃(s)+2Na₂CO₃(s) [symbol] Na₄Al₂O₅(s)+2CO₂(g)

and

Na₄Al₂O₅(s)+2H₂O(l) [symbol] Al₂O₃(aq)+4NaOH(aq).

### Thermal Decomposition Causticization

The final process is much simpler than the Direct or Auto Causticization. The carbonate formed as a byproduct of hydrogen production is simply heated until it decomposes (decarbonization) into an oxide and gaseous CO₂, and the oxide is hydrolyzed to produce the caustic. In this type of reaction, heat is the decarbonization agent. Examples of the decomposition are:

Na₂CO₃(s)+Δ [symbol] Na₂O(s)+CO₂(g)

K₂CO₃(s)+Δ [symbol] K₂O(s)+CO₂(g)

and

Li₂CO₃(s)+Δ [symbol] Li₂O(s)+CO₂(g)

Subsequent hydrolysis reactions are:

Na₂O(s)+H₂O(l) [symbol] 2NaOH(aq)

K₂O(s)+H₂O(l) [symbol] 2KOH(aq)

and

Li₂O(s)+H₂O(l) [symbol] 2LiOH(aq)

It should be noted that thermal decomposition of the carbonates may be difficult and the metal oxides formed from the decomposition may be highly reactive and unstable. Furthermore, the reaction of the oxide and water (the hydrolysis) may be violent and release a significant quantity of heat (i.e. the decarbonization agent is recovered). This heat may be recycled to the system as needed.

While many of the above examples are shown using Na as the caustic metal, it should be emphasized that other metals such as K or Li advantageously may take the place of Na in some reactions.

The foregoing discussion and description are not meant to be limitations upon the practice of the present invention, but rather illustrative thereof. It is the following claims, including all equivalents and obvious variations thereof, in combination with the foregoing disclosure which define the scope of the invention.

We claim:

1. A process for producing hydrogen gas comprising the steps of
reacting an organic substance with a metal hydroxide producing hydrogen gas and a metal carbonate;
recovering said metal hydroxide from said metal carbonate; and
recycling said metal hydroxide to said step of reacting an organic substance with a metal hydroxide.

2. The process of claim 1, wherein said step of recovering said metal hydroxide comprises recausticization.

3. The process of claim 2, wherein said step of recausticization comprises the steps of:
a) decarbonization of said carbonate to form an intermediary product and CO₂ gas; and
b) hydrolysis of said intermediary product to form said metal hydroxide.

4. The process of claim 3, wherein said step of decarbonization of said carbonate includes reacting said carbonate with a decarbonization agent.

5. The process of claim 4, wherein said step of hydrolysis of said intermediary product forms said metal hydroxide and reforms said decarbonization agent.

6. The process of claim 4, wherein said recausticization is direct causticization and said decarbonization agent is insoluble in alkaline solution.

7. The process of claim 6, wherein said decarbonization agent is a titanium oxide.

8. The process of claim 6, wherein said decarbonization agent is a manganese oxide.

9. The process of claim 6, wherein said decarbonization agent is an iron oxide.

10. The process of claim 4, wherein said recausticization is autocausticization and said decarbonization agent is soluble in alkaline solution.

11. The process of claim 10, wherein said decarbonization agent is a borate salt.

12. The process of claim 10, wherein said decarbonization agent is a phosphate salt.

13. The process of claim 10, wherein said decarbonization agent is a silicate salt.

14. The process of claim 10, wherein said decarbonization agent is an aluminate.

15. The process of claim 4, wherein said recausticization is thermal decomposition causticization and said decarbonization agent is heat.

16. The process of claim 1, wherein said metal of said metal hydroxide is one or more metals from the group consisting of Na, K and Li.
